(19) United States
(12) Patent Application Publication
(10) Pub. No.: US 2008/0014377 A1
(43) Pub. Date: Jan. 17, 2008

(54) Floral pick

(76) Inventors: Case van Wingerden, Carpinteria, CA (US); Diana Filippin, San Luis Obispo, CA (US); Qing Lin, PingHu Town (CN)

Correspondence Address: KNOBBE MARTENS OLSON & BEAR LLP, 2040 MAIN STREET, FOURTEENTH FLOOR, IRVINE, CA, 92614, US

(21) Appl. No.: 11/488,923

(22) Filed: Jul. 17, 2006

(51) Int. Cl. G09F 17/00

(52) U.S. Cl. 428/7

(57) ABSTRACT

Embodiments include floral picks for use with decorative foliage. One embodiment includes a floral pick including a body comprising a first body member and a second body member. The second member has a recess configured to receive the first body member. At least one wing includes a central portion positioned between the first body member and the second body member. A shaft is coupled to the body.

### RELATED APPLICATIONS

This application is related to U.S. Design patent application Ser. No. ______, Attorney Docket No. WFLOR.006DA, filed on even date, which is hereby incorporated by reference in its entirety.

### BACKGROUND OF THE INVENTION

1. Field of the Invention

The invention relates to floral picks, such as included in decorative foliage.

2. Description of the Related Technology

Floral picks are included as a decorative flourish to cut flowers, potted plants or other decorative foliage. However, many floral picks are hand made, or delicate constructs that are not easily transported or stored. In addition, floral picks are often constructed of materials that are not robust when wet. Accordingly, a need exists for sturdy floral picks that are also easily manufactured and transported.

### SUMMARY OF CERTAIN INVENTIVE ASPECTS

The system, method, and devices of the invention each have several aspects, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Embodiments” one will understand how the features of this invention provide advantages that include sturdy and more easily manufactured floral picks.

One embodiment includes a floral pick. The floral pick includes a body comprising a first body member and a second body member. The second body member has a recess configured to receive the first body member. The floral pick further includes at least one wing having a central portion positioned between the first body member and the second body member. The floral pick further includes a shaft coupled to the body.

One embodiment includes a floral pick. The floral pick includes at least one wing and a body coupled to the wing. The floral pick further includes spring having a distal end and a proximal end. The proximal end is received into the opening of the body. The floral pick further includes a shaft connected to the distal end of the spring.

One embodiment includes a floral pick. The floral pick includes a body defining an opening and comprising a first body member and a second body member. The second body member has a recess configured to receive the first body member. The floral pick further includes at least one wing having a central portion positioned between the first body member and the second body member. The floral pick further includes a spring having a distal end and a proximal end, the proximal end being received into the opening of the body. The floral pick further includes a shaft connected to the distal end of the spring.

### BRIEF DESCRIPTION OF THE DRAWINGS

FIG. 1 is a perspective view illustrating one embodiment of a floral pick;

FIG. 2 is a left side view thereof;

FIG. 3 is front view thereof;

FIG. 4 is a rear view thereof;

FIG. 5 is a top view thereof; and

FIG. 6 is a bottom view thereof.

FIG. 7 is a top view illustrating one embodiment of a disassembled body of the floral pick such as illustrated in FIG. 1.

FIG. 8 is a side view illustrating one embodiment of a disassembled shaft of the floral pick such as illustrated in FIG. 1.

FIG. 9 is a side view illustrating one embodiment of the disassembled body of the floral pick illustrated in FIG. 7.

FIG. 10 is a top view illustrating one embodiment of the disassembled front wing segment of the floral pick illustrated in FIG. 7.

FIG. 11 is a top view illustrating one embodiment of the disassembled rear wing segment of the floral pick illustrated in FIG. 7.

### DETAILED DESCRIPTION OF CERTAIN EMBODIMENTS

The following detailed description is directed to certain specific embodiments of the invention. However, the invention can be embodied in a multitude of different ways as defined and covered by the claims. In this description, reference is made to the drawings wherein like parts are designated with like numerals throughout.

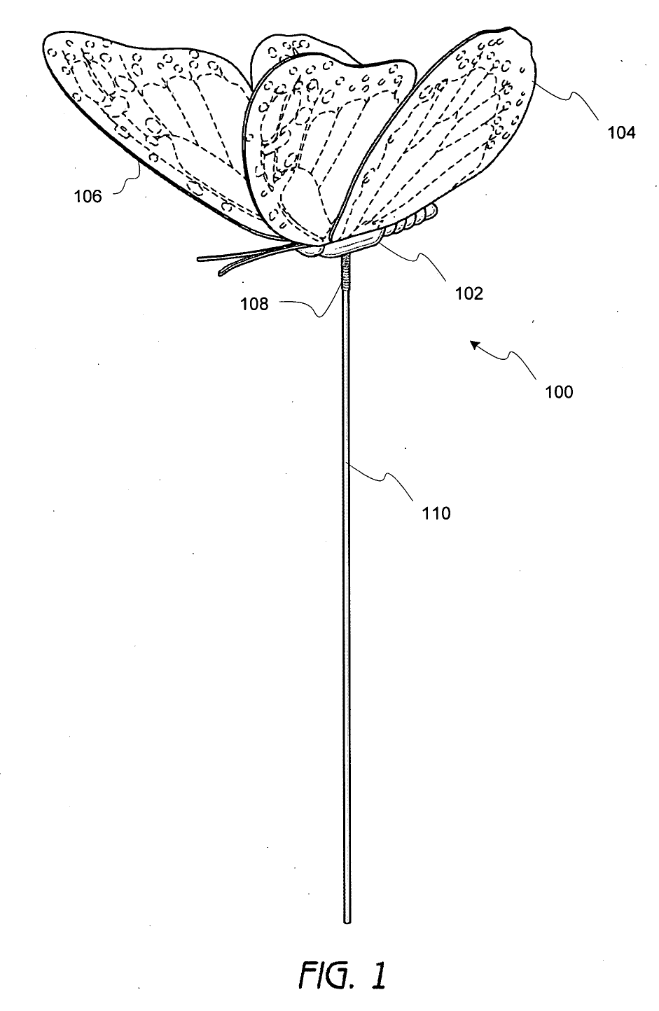

FIG. 1 is a perspective view of a floral pick 100 having the form of a butterfly. It is to be understood that the butterfly shape is merely exemplary, and that the decorative element can take the form of other insects, birds, etc. The floral pick 100 includes a body 102 that couples rear wing segments 104 and front wing segments 106 to a shaft 110 via a spring 108. In the illustrated embodiment, the body. 102 is formed of a stiff plastic material. In other embodiments, the body 102 may be formed of materials such as metal or wood. In one embodiment, the spring 108 and shaft 110 are formed of a metal material such as steel or aluminum. However, other suitable materials may be used such as plastic or wood (for the shaft 110).

When the floral pick 100 is moved, the spring 108 adds a vibrational movement that gives the pick a more lifelike appearance, e.g., of a butterfly flying over a bouquet or arrangement that includes the pick 100. In one embodiment, the wings 104 and 106 are also configured to move or flap in relation to the body 102. The vibrational movement of the spring 108 further drives such movement of the wings 104 and 106 to further contribute to the ornamental effect of the pick 100. In addition, the somewhat independent movement of both rear wings 104 and front wings 106 also adds to the ornamental effect.

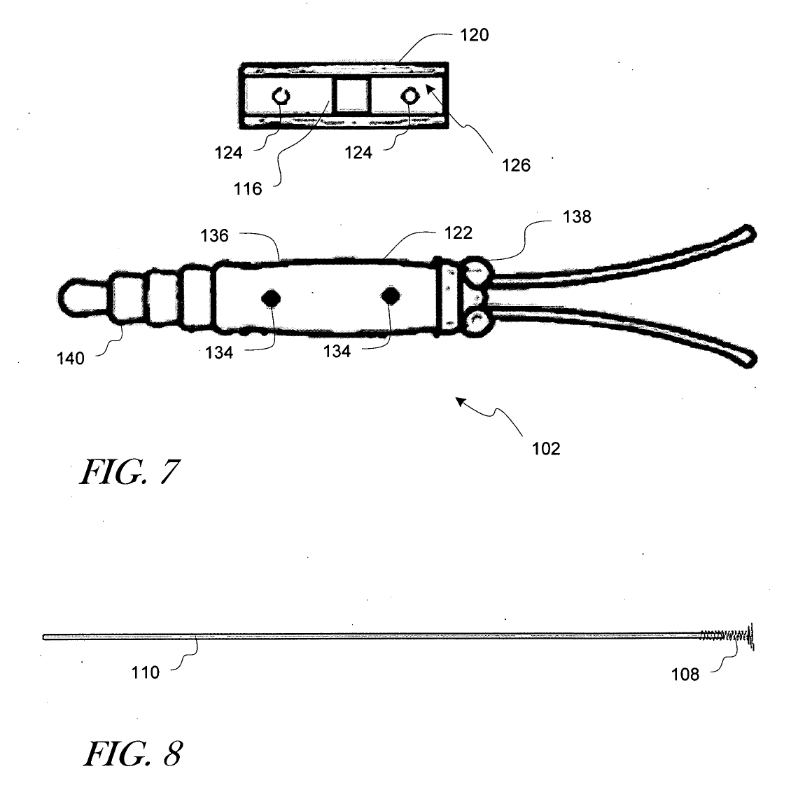

In one embodiment, the spring 108 is received into an opening or recess(See FIGS. 6 and 7) in the body 102. In one such embodiment, the winding of the end of the spring 108 that is distal to the body 1.02 is larger than the distal end that is affixed to the shaft 110 and, in particular, larger than the opening of the recess so that the spring is affixed to the body 102. In other embodiments, the spring may be glued, epoxied, or other wise affixed to the body. In one embodiment, rather than a recess, the body 102 may include a detent (not shown) extending from the bottom of the body and around which the spring is affixed, either by being glued, screwed, or press fit to the detent. Advantageously, in embodiments in which the spring 108 is received into the body 102, the spring 108 is held secure without additional fasteners.

Each of the wings 104 and 106 comprises a substantially planar sheet of material. In one embodiment, the wings 104 and 106 have a decorative pattern formed or printed on the surface of the wings 104 and 106. In one embodiment, the wings are formed of a water resistant material such as plastic. However, in other embodiments, other materials such as paper, foil, or other suitable materials may be used. In one embodiment, each of the wings 104 and 106 is creased or bent upward where it is connected to the body to provide the appearance of a butterfly (or in other embodiments, other insects or other similar decorative forms) in flight. Advantageously, plastic wings are not easily damaged by water as paper or silk wings may be. In addition, plastic wings can be formed efficiently and in volume using known plastic forming methods.

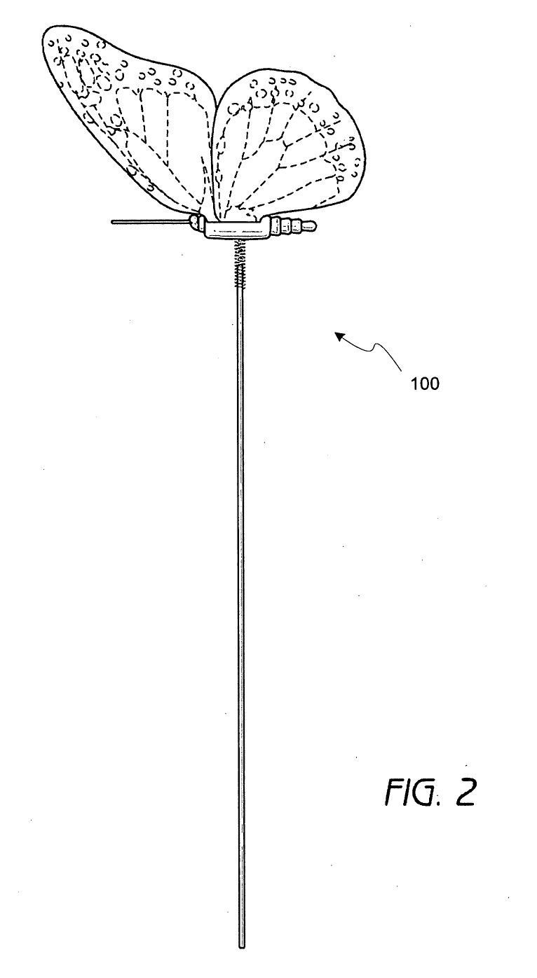

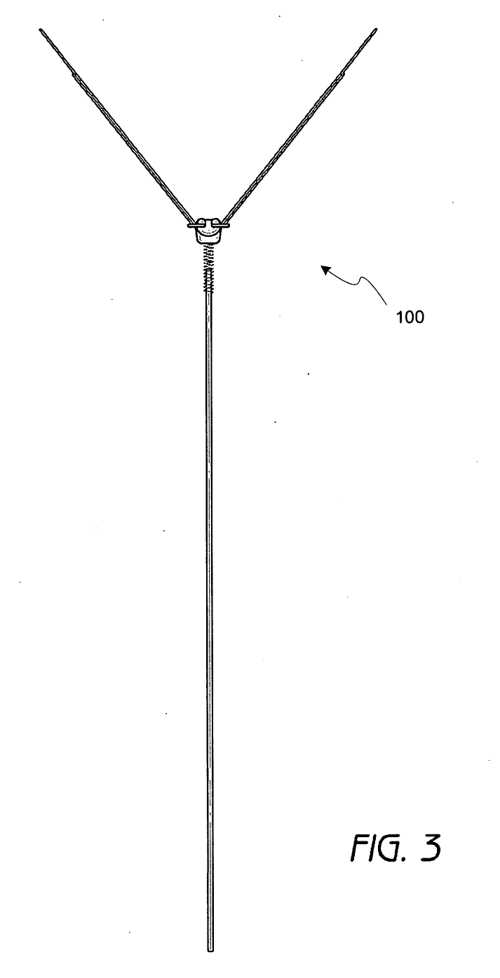

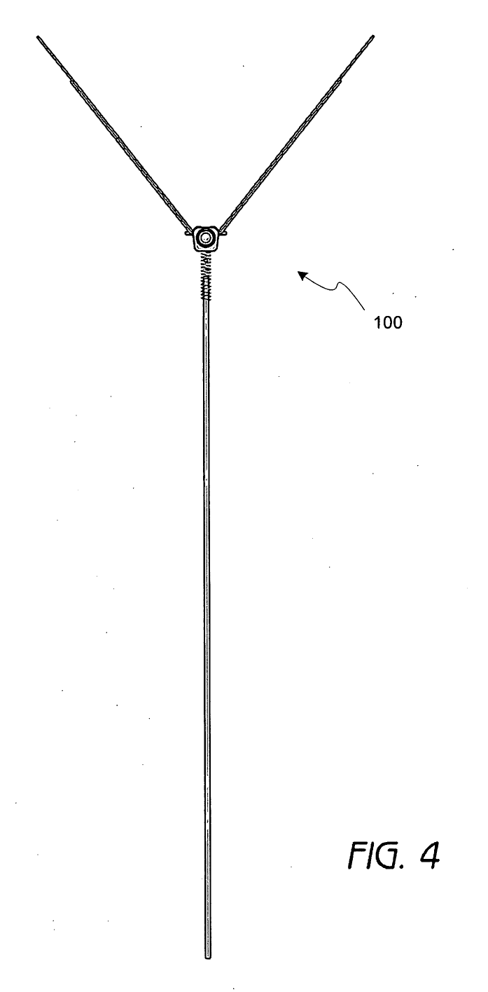

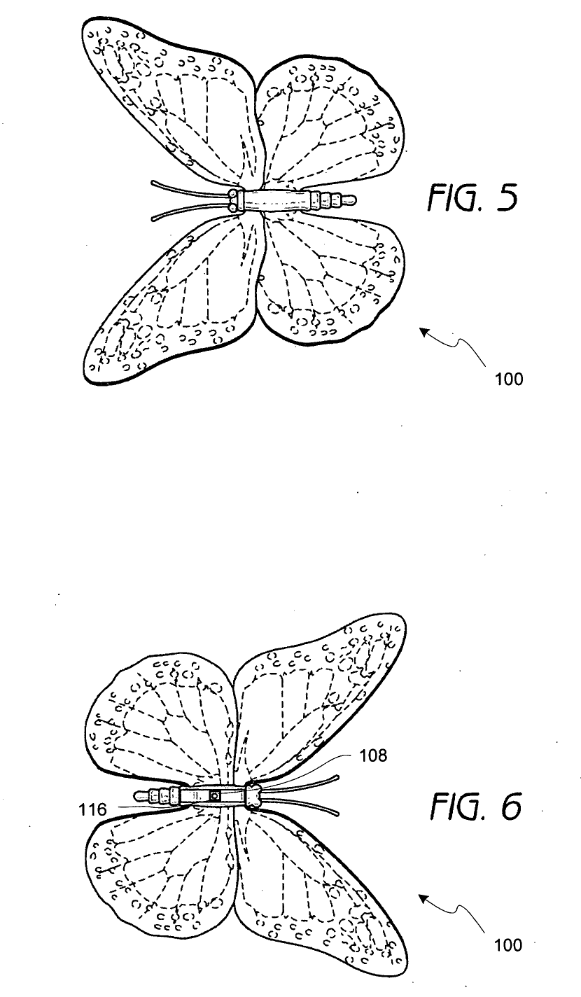

FIGS. 2, 3, 4, 5, and 6 illustrate left, front, rear, top and bottom views of the floral pick 100. FIG. 6 illustrates the connection of the spring 108 to the body 102 according to one embodiment. In this embodiment, the spring 108 is received into an opening 116 in the body 102.

FIG. 7 is a top view illustrating one embodiment of a disassembled body 102 of the floral pick 100. The body 102 includes a lower member 120 that is coupled to an upper member 122. In one embodiment, the wings 104 and 106 are positioned between the lower and upper members 120 and 122. In one embodiment, the lower member 120 includes the opening 116 configured to receive the spring 108. In one embodiment, the upper member 122 includes one or more posts 134 extending from a central portion 136. In one embodiment, the lower member 120 includes openings 124 into which posts 134 on the upper member are press fit to affix the upper member 122 to the lower member 120. In one embodiment, the wings 104 and 106 are positioned therebetween to affix the wings to the body. In one embodiment, the upper and lower members 122 and 120 of the body 102 are affixed together by other suitable fasteners such as glue or screws.

FIG. 8 is a side view illustrating one embodiment in which the spring 108 has a spiral at its proximal end that is larger in diameter than the opening 116 of the lower member 120. Prior to assembly of the upper and lower members 122 and 120, the smaller distal end of the spring 108 is pushed through the opening 116. In one embodiment, the shaft 110 is inserted into the end of the spring 108. In other embodiments, the shaft may be hollow or have a recess in its end for receiving the spring 108. When the lower member 120 is then attached to the upper member 122, the larger proximal end of the spring is held in place within the body 102 of the pick 100.

FIG. 9 is a side view illustrating one embodiment of the disassembled body 102 of the floral pick 100. In one embodiment, the central, head, and tail portions 136, 138, and 140 of the upper member 122 define a recess 142 into which the posts 134 extend. In one embodiment, the lower member 120 is received into the recess 142 when affixed to the upper member 122.

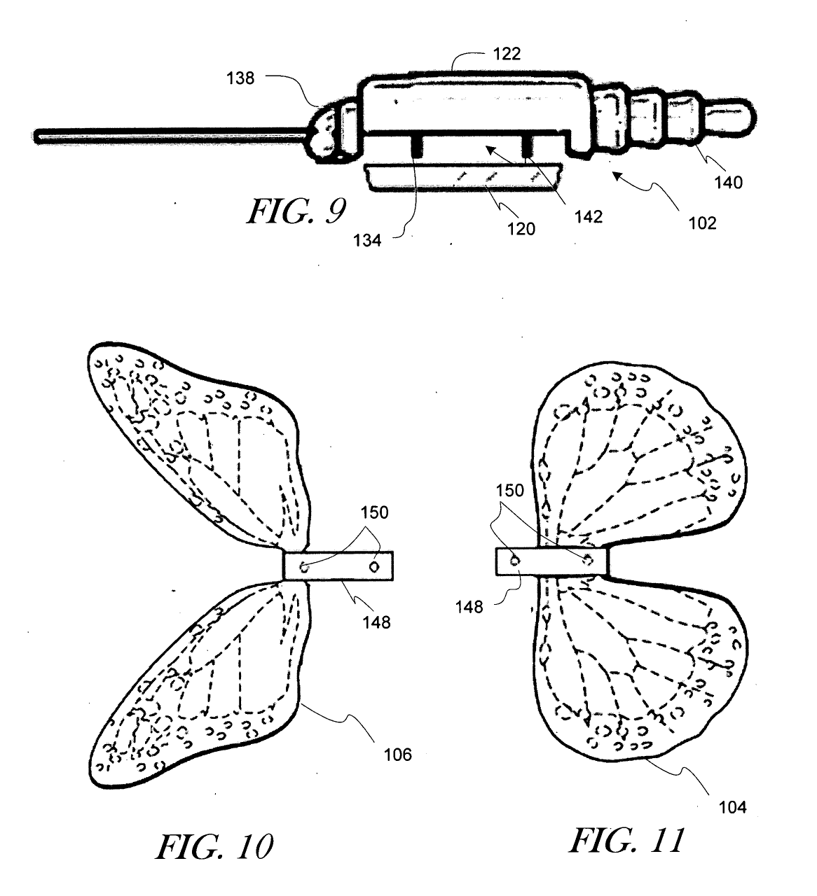

FIG. 10 is a top view illustrating one embodiment of the disassembled front wing segment 106 of the floral pick 100. FIG. 11 is a top view of illustrating one embodiment of the disassembled rear wing segment 104 of the floral pick 100. In the illustrated embodiment, each of the wing segments 104 and 106 includes a substantially rectangular central portion 148 that has substantially the same cross section as the lower member 122 so that the central portion 148 is hidden within the body 102 when the wings are affixed while still providing sufficient material for affixing the wings. In one embodiment, the central portions 148 each include one or more openings 150 that are configured to receive the posts 134 of the upper member 122 of the body 102 and thus hold the wings 104 and 106 in position within the body 102. However, in other embodiments, the wings 104 and 106 may be held in place by other suitable fasteners such as glue or epoxy.

While the illustrated embodiment includes a body formed of upper and lower members 122 and 120, other embodiments may include only a single body member, or more than two body members that are configured to affix the wings. For example, in one embodiment, the body may include one or more members that define a slot that receives the wings.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A floral pick comprising:
a body comprising a first body member and a second body member, the second body member having a recess configured to receive the first body member;
at least one wing having a central portion positioned between the first body member and the second body member; and
a shaft coupled to the body.

2. The floral pick of claim 1, wherein the body defines an opening configured to couple the shaft to the body.

3. The floral pick of claim 2, wherein the second body member defines the opening.

4. The floral pick of claim 2, further comprising a spring having a distal end and a proximal end, the proximal end being received into the opening of the first body member; and wherein the shaft is connected to the proximal end of the spring.

5. The floral pick of claim 1, wherein said first body member comprises one or more posts and said second body member comprises one or more recesses configured to receive the posts.

6. The floral pick of claim 1, wherein the at least one wing comprises a substantially planar sheet of plastic.

7. The floral pick of claim 1, wherein the at least one wing has a decorative pattern formed thereon.

8. A floral pick comprising:
at least one wing;
a body coupled to the wing;
a spring having a distal end and a proximal end, the proximal end being received into the opening of the body; and
a shaft connected to the distal end of the spring.

9. The floral pick of claim 8, wherein said body comprises first and second body members, and wherein the first body member comprises one or more posts and the second body member comprises one or more recesses configured to receive the posts.

10. The floral pick of claim 8, wherein the at least one wing comprises a substantially planar sheet of plastic.

11. The floral pick of claim 8, wherein the at least one wing has a decorative pattern formed thereon.

12. A floral pick comprising:
a body defining an opening and comprising a first body member and a second body member, the second body member having a recess configured to receive the first body member;
at least one wing having a central portion positioned between the first body member and the second body member;
a spring having a distal end and a proximal end, the proximal end being received into the opening of the body; and
a shaft connected to the distal end of the spring.

13. The floral pick of claim 12, wherein the second body member defines the opening.

14. The floral pick of claim 12, wherein the at least one wing comprises a substantially planar sheet of plastic.

15. The floral pick of claim 12, wherein the at least one wing has a decorative pattern formed thereon.

16. The floral pick of claim 12, wherein the diameter of the spring is larger at its proximal end that at its distal end.

17. The floral pick of claim 12, wherein the diameter of the spring at its distal end is larger than the opening of the body.
